(19) United States
(12) Patent Application Publication
(10) Pub. No.: US 2020/0143330 A1
(43) Pub. Date: May 7, 2020

(54) TASK PRIORITIZATION PLATFORM FOR MULTIPLE MEDIA CHANNELS

(71) Applicant: International Business Machines Corporation, Armonk, NY (US)

(72) Inventors: Sailaja S. Perumalla, VISAKHAPATNAM (IN); Shanthan Chamala, Malvern, PA (US); Neela Komaragiri, Visakhapatnam (IN); Raghupatruni Nagesh, VISAKHAPATNAM (IN)

(21) Appl. No.: 16/179,924

(22) Filed: Nov. 3, 2018

(51) Int. Cl. G06Q 10/10; G06F 17/27; G10L 15/08; G06Q 10/06

(52) U.S. Cl. CPC G06Q 10/1097; G06F 17/2785; G10L 2015/088; G06Q 10/063114; G10L 15/08

(57) ABSTRACT

An example operation may include one or more of receiving a communication between a sending system and one or more receiving systems via collated feeds from a plurality of types of media channels, detecting a task to be performed from content included in the communication based on one or more keywords within the content which are associated with a task type from among a plurality of task types, determining a priority of the detected task based on a timeline attribute and a non-time related attribute of the detected task, and storing an identification of the detected task within a user interface based on the identified priority.

### TECHNICAL FIELD

This application generally relates to a system for detecting tasks and setting reminders for the detected tasks, and more particularly, to a centralized platform that receives a feed collated from various media channels and cognitively prioritizes tasks from across the various media channels.

### BACKGROUND

Because of the widespread usage of mobile devices and computers, people now rely more on devices for organizing and scheduling tasks than traditional calendars. People also tend to think about multiple things at the same time causing them to lose concentration or otherwise forget about details and tasks that need to be performed. For example, certain things may stay in the mind for a long time while some fade away. Some things may need attention immediately, while some things can be re-visited at a later point in time. To remember a schedule of activities over a long period of time can be challenging given demanding lifestyles. Often, a person will set reminders for themselves using calendar applications on their mobile devices, organizers, or even jot down sticky notes to keep track of everything.

However, people are busy and can get distracted thereby forgetting about a task or other type of reminder. This can lead to missing tasks altogether. For example, a user may write down a list but fail to consciously draw their attention to the activities at the needed time (hour/day). Also, tasks develop in many different situations and across different types of communications channels making writing a list or storing reminders in a calendar application difficult for some types of tasks. For example, tasks may be requested during emails, phone calls, while web browsing, and the like. Typically, different media channels require separate scheduling of tasks. For example, tasks provided via email may be stored within an email application while tasks provided during a phone call must be jotted down on a sticky note or kept within a calendar/book. This lack of cohesion requires a user to organize tasks in multiple different ways which can be time consuming.

Accordingly, what is needed is an improved mechanism for setting task reminders and keeping track of busy schedules in a way that does not require different mechanisms for different types of media channels.

### SUMMARY

One example embodiment may provide a system that includes one or more of a network interface configured to receive a communication between a sending system and one or more receiving systems via a feed collated from a plurality of types of media channels, and a processor configured to one or more of detect a task to be performed from content included in the communication based on one or more keywords within the content, determine a priority of the detected task based on one or more of a timeline and a non-time related attribute of the task, and store an identification of the detected task within a task user interface based on the identified priority.

Another example embodiment may provide a method that includes one or more of receiving a communication between a sending system and one or more receiving systems via a feed collated from a plurality of types of media channels, detecting a task to be performed from content included in the communication based on one or more keywords within the content, determining a priority of the detected task based on one or more of a timeline and a non-time related attribute of the task, and storing an identification of the detected task within a task user interface based on the identified priority.

A further example embodiment may provide a non-transitory computer readable medium comprising instructions, that when read by a processor, cause the processor to perform one or more of receiving a communication between a sending system and one or more receiving systems via a feed collated from a plurality of types of media channels, detecting a task to be performed from content included in the communication based on one or more keywords within the content, determining a priority of the detected task based on one or more of a timeline and a non-time related attribute of the task, and storing an identification of the detected task within a task user interface based on the identified priority.

### BRIEF DESCRIPTION OF THE DRAWINGS

FIG. 1 is a diagram illustrating an environment of a centralized platform for collating tasks according to example embodiments.

FIGS. 2A-2C are diagrams illustrating a process of generating a task from an email communication according to example embodiments.

FIG. 3 is a diagram illustrating a process of generating a task from a phone call according to example embodiments.

FIG. 4 is a diagram illustrating a smart task list in which tasks are ordered based on priority according to example embodiments.

FIG. 5 is a diagram illustrating a method for detecting a task from a feed collated from multiple media channels according to example embodiments.

FIG. 6 is a diagram illustrating a computer system configured to support one or more of the example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” may have been used in the description of embodiments, the application may be applied to many types of network data, such as, packet, frame, datagram, etc. The term “message” also includes packet, frame, datagram, and any equivalents thereof. Furthermore, while certain types of messages and signaling may be depicted in exemplary embodiments they are not limited to a certain type of message, and the application is not limited to a certain type of signaling.

Example embodiments are directed to methods, devices, networks and/or systems, which support a central platform for detecting and collating tasks from across different media channels into a single list of pending tasks enabling a user to aggregate all of their reminders and to help prioritize the list within a common interface. Each user may have their own task list which is automatically managed by the platform. According to various embodiments, the platform may automatically detect a task from a web-based activity such as an email, an instant message, web-browser, and the like. As another example, the platform may automatically detect a task to be performed from an audio conversation conducted via a phone call. In this case, the platform may convert the audio to text using a speech-to-text converter, perform speech recognition to identify keywords, and the like. In some embodiments, the platform may perform analytics on the audio using audio-based machine learning algorithms which identify the keywords using conversion or recognition methods. The platform may identify and consider relevant to-do items (i.e., tasks) that may be stored as a reminder from various sources and tag those to the right owner, per the time, availability and appropriateness. The platform s intelligent in that it can identify the tasks based on historical communications or by referring to the historical task execution and delivery information to meet scheduled timelines. The system is designed for effective resource and work management using historical data, resources, skills and interests.

The platform can detect tasks that are to be performed from multiple media channels including voice (e.g., cellular, land lines, etc.) and data lines (Internet) such as cable, DSL, and the like. The platform can use analytical analysis to intelligently identify tasks based on keywords learned from historical tasks. In some embodiments, the platform may dynamically detect keywords based on prior content of a particular user, a group of users, and the like. Here, the keywords may be detected based on historical communications of a user, previous tasks uploaded by a user, tasks stored by other users, and the like. Additionally, users can upload historic tasks/activities of their self (or a group) so that platform can perform intelligent analytics and recommend suggestions or recommendations for reminders on future tasks and activities.

In some embodiments, the platform can derive the experience of a user, expertise required to do a task, availability of the user, and the like, based on a consideration of a work load for the user, time required to complete the task, and the like. The platform can create reminders when nearing completion, pop the status updates, prioritize on the criticality factor, most productive hours on a given day, and the like, to distinguish from the tasks that require more/less efforts.

Email programs such as Microsoft Outlook offer users the ability to create tasks such as meeting requests. These tasks are then emailed to other users allowing them to accept/deny the tasks. However, these tasks must be manually created by a user through the email program. The example embodiments provide a platform that does not rely on a user to manually create a task, but instead, can automatically detect a task in real-time as the user is exchanging communications (e.g., email, phone call, instant message, browser activity, etc.) without the user having to specifically type out a task. Furthermore, the platform can push a notice to a screen of the user device asking the user whether they would like to save the detected task in a task list associated with the user. In some embodiments, the platform may determine a priority of the task even when a timeline is not specifically mentioned or provided by the communication based on historical knowledge. Furthermore, the platform also has the capability to create tasks for other users too.

In some embodiments, the platform may consider various factors when assigning tasks. For example, if a user needs to be tagged with a high priority to-do task item but the user is already overloaded with other items to be performed, then the platform could make a decision to re-prioritize the task to a less urgent task, offload and assign one or more tasks to less loaded users, etc. Additionally, a user who has requested a task activity via the communication does not have to manually follow up on these activities to make sure they are jotted down or stored in a calendar application. Instead the user may look up the current status on assigned task activities in their task list and adjust any necessary details (such as changed deadline, priority, etc.).

The platform may detect a task automatically from content within a phone call, an email, an instant message, and the like. In some cases, the platform may create a task based on content aggregated from across multiple communications (e.g., a chain of emails, etc.). The platform may identify keywords within content of the communications and identify the keywords as being associated with a particular type of task, a priority, one or more users, a timeline, and the like. The platform may also identify or predict other features associated with the task such as an amount of work required, a completion percentage, an experience/skill level associated with the task, and the like. In some embodiments, any participant or non-participant from a communication (e.g., email, call, message, etc.) can push a task to one or more other users, depending on the status. The task may deploy depending on the utilization levels of individuals on any given day.

In some embodiments, the task detection and prioritization platform is a cloud-based application and is integrated with multiple systems to be able to draw the sources, match and delegate tasks/to do items, however embodiments are not limited thereto. As another example, the platform could be a web server, a user device, a service, and/or the like. The platform may be connected to the user's device through a network, one or more application programming interfaces (APIs), and the like. The platform can also run insights on historical data and make decisions.

Some of the benefits of the platform include the ability of the platform to automatically detect a task and assign a priority to the task without requiring a user to manually input or track the task. The platform can also generate tasks for different users at the same time based on the communication. The tasks may be prioritized based on timelines included in the communication or non-time related attributes such as the amount of work required and the like which may be predicted based on historical data. The platform may alert users about the deadlines for quicker action, predict the turn around time and accordingly distributes/delegate the tasks. The platform may also perform dynamic prioritization of tasks based on timelines and non-time related attributes, effectively utilize available resources, and keep efforts to a minimum during large scale tasks situations such as emergencies.

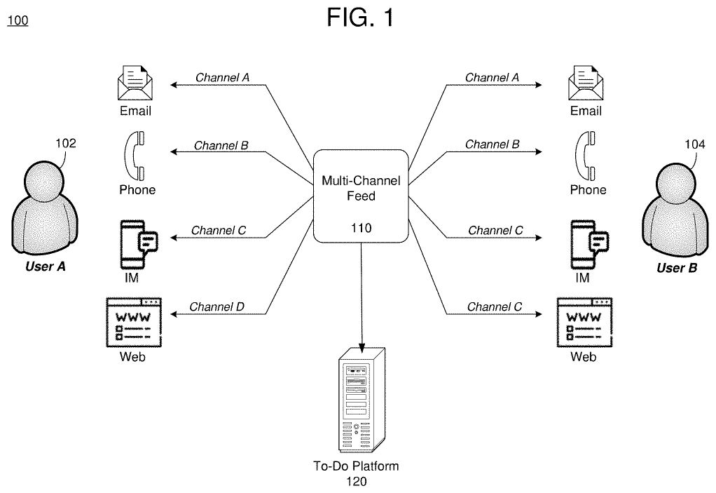

FIG. 1 illustrates an environment 100 of a centralized platform 120 for collating tasks according to example embodiments. Referring to the example of FIG. 1, a pair of users 102 and 104 may communicate with each other via various channels. In the example of FIG. 1, the channels include email (channel A), phone (channel B), instant message (channel C), and web-browser communications (channel D). The embodiments are not limited to these types of channels, and this is merely for purposes of example. The platform 120 may collate feeds from the plurality of channels into collated feed 110. Furthermore, the platform 120 may identify tasks to be performed from the collated feed 110. Here, the platform 120 may be a cloud platform or other central system such as a web server that intercepts or otherwise receives network and/or Internet-based communications from the user 102, the user 104, or both.

Upon detecting a task for a user (e.g., user 102 or user 104), the platform may push the task to a screen of a user device associated with the user requesting the user to approve or deny the detected task. In this way, a user may be provided with a list of tasks which have been possibly detected by the platform 120 and decide which tasks are recorded for future reminders, etc. As another example, the platform 120 may automatically store the tasks in a task list of the user. Once a task is stored, reminders can be generated (e.g., automatically by the platform 120, manually by the user, etc.)

In one embodiments, the platform 120 may detect tasks from keywords that are spoken by one or more of the users 102 and 104 during a phone call between the two users, and which pass through the collated feed 110. As another example, the platform 120 may detect tasks from an email (or chain of emails) as they are sent between user 102 and user 104 and pass through the collated feed 110. Although not shown, the platform 120 may generate a respective list for the respective users 102 and 104, and output the lists automatically or in response to a request. In some cases, a communication between the user 102 and the user 104 may cause a task to be created for another user (not shown). In this example, the platform may automatically push the task to a device of the other user enabling the user to accept/reject the task.

In the example of FIG. 1, the platform 120 may sync in all the relevant messages/calls that have a task included therein through one or more of APIs, services, applications, or other programs. The platform can prioritize tasks or set time limits. The platform 120 may tag a specific reminder time for a task so that a user does not get repeated reminders. Furthermore, the platform 120 may draw insights based and trends on historical data and forecast prospective tasks from other communications, historical data, historical communications between a sender and receiver, and the like. The platform 120 may auto suggest recommendations for addressing the tasks based on the drawn insights. In some embodiments, the platform 120 may identify task dependencies and auto create tasks against those dependencies while alerting users about the dependencies. In some embodiments, the platform 120 may delegate/share the load to/with peer team members in case of unforeseen reasons like unplanned vacations, unplanned priority work items, and the like.

As a result, no additional reminder apps may be needed for any of the different media channels. Therefore, a user may be diverted less from more important tasks. The user may be confident that they are not missing out on any reminders and focus more attention on the tasks at hand. The reminders may be hassle-free and easy to configure if a user desires. Over time, the platform may become more efficient and resourceful with minimal efforts. The platform can involve all the relevant parties and can make decisions on its own even when the other parties are not participants in the conversation/email that generated the task. As a result, everyone connected to the activities (even indirectly) may be made aware of the status. The platform may record a history of the identified tasks enabling a user to review/use at a later point.

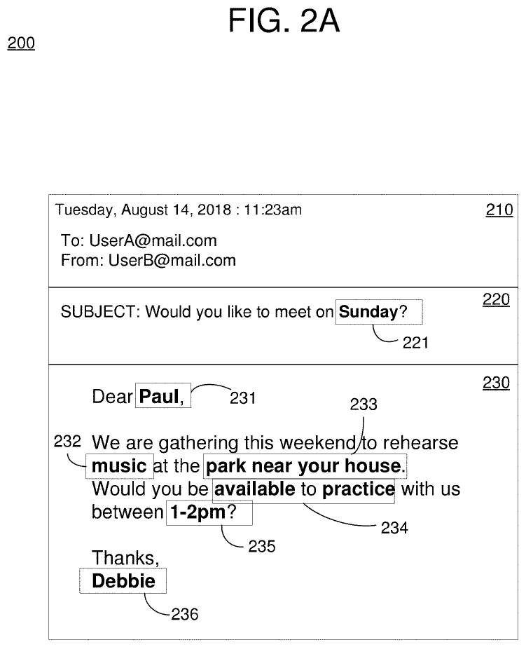

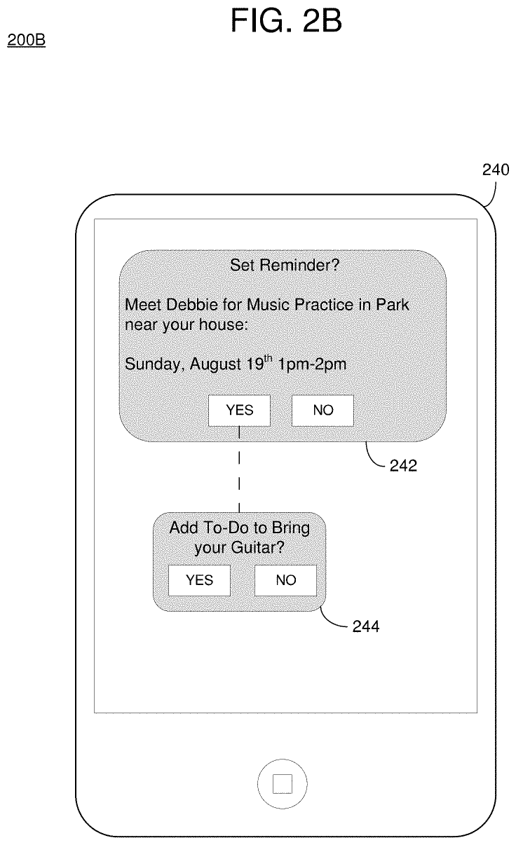

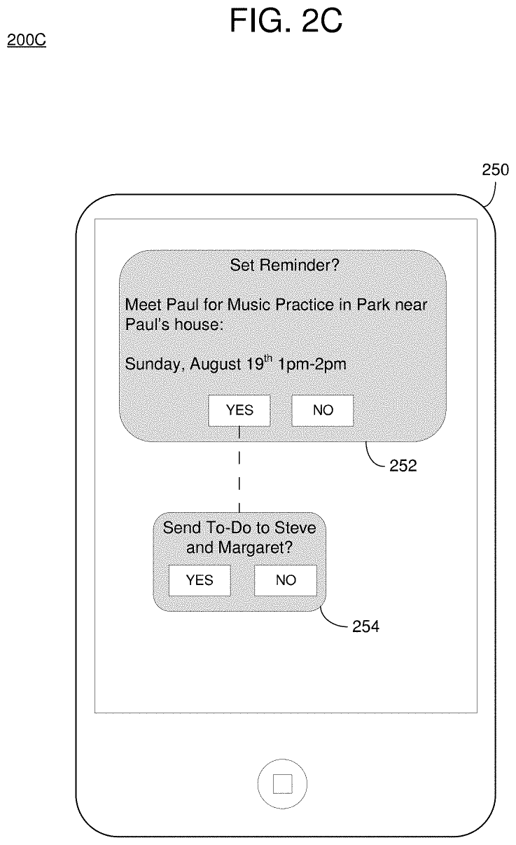

FIGS. 2A-2C illustrate a process of generating tasks from an email communication according to example embodiments. Referring to FIG. 2A, an email 200 is sent from a sending system to a receiving system (e.g., users 102 and 104 in FIG. 1, etc.) In this example, the email communication 200 has multiple components from which keyword data may be gleaned. For example, the email communication 200 may include metadata 210, a subject line 220, a body 230, and the like. The platform may scan for keywords in any of these areas of an electronic message such as the email 200 or other types of messages such as short message service (SMS), multimedia message service (MMS), and the like.

In the example of FIG. 2A, the system identifies a keyword 221 within the subject line 220, and a plurality of keywords 231-236 within the body 230 of the email communication 200. In this example, the keywords are detected from a single email. However, it should be appreciated that content from a chain of emails may be aggregated to generate a single task. The keywords may include locations, times, dates, persons, places, items, goods, and the like. A machine learning algorithm may be trained over time based on historical tasks. Therefore, the algorithm can learn how to identify tasks based on historical emails, instant messages, etc.

Based on the email communication 200, the platform detects and creates a task 200B for a receiver of the email 200, as shown in FIG. 2B, and detects and creates a task 200C for a sender of the email 200, as shown in FIG. 2C. Referring to FIG. 2B, the platform generates a notice 242 which is pushed to a screen of a receiver system 240. Here, the notice 242 requests whether the user would like to set a reminder for a meeting automatically detected from the content of the email 200 shown in FIG. 2A. Here, keyword content may be used to populate the notice 242. For example, the notice 242 may include a template with gaps which are filled-in with keywords from the email 200, however embodiments are not limited thereto.

In addition to the notice 242, the platform may draw insight from the email 200 and historical communications between the sender and the receiver. Here, the platform may detect that the meeting is related to music practice. The platform may associate music and guitar based on a database of information kept about the user. Here, the platform may request the user to bring their guitar to the meeting in the notice 244. Different insights may be drawn based on context of the communications and the user.

Referring to FIG. 2C, the platform generates a notice 252 which is pushed to the screen of the sender system 250. In this case, the notice 252 is similar to the notice 242 sent to the receiver, but modified based on the user. In addition to the notice 252, the platform may draw insight from email 200 and historical communication of the sender. In this case, the platform detects that two other users (Steve and Margaret) are often included in music practice. In this case, the platform may ask the sender if they would like to automatically push tasks to computing systems associated with Steve and Margaret via notice 254.

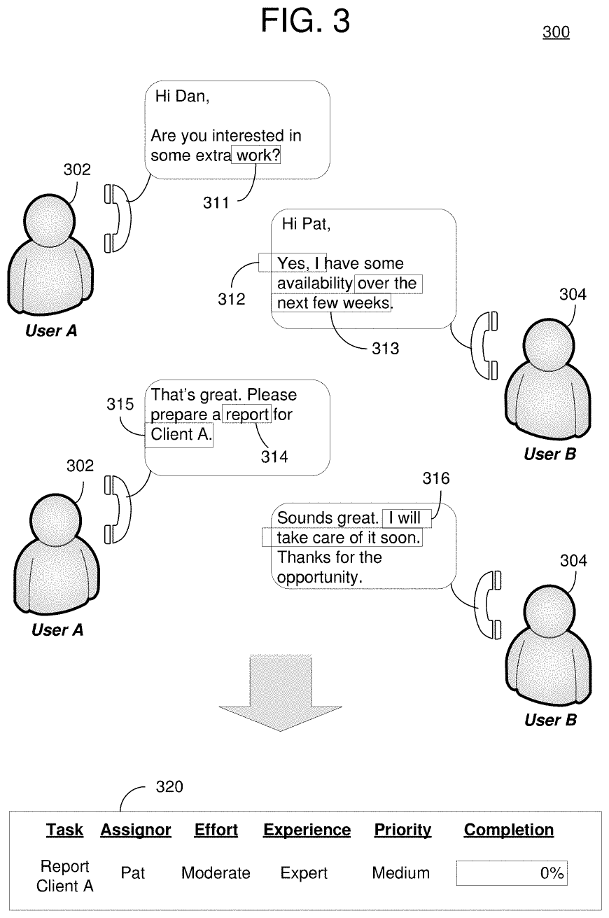

FIG. 3 illustrates a process 300 of generating a task from a phone call according to example embodiments. Referring to FIG. 3, a pair of users 302 and 304 conduct a telephone conversation which is monitored by the platform described herein. In this example, a task 320 is detected and created by the platform based on content within the phone conversation. In this example, a plurality of communications occur during the conversation. The platform may identify keywords that are spoken during the conversation to generate a task for one or more of the users 302 and 304, and/or a user who is not apart of the telephone conversation. In this example, the platform detects a plurality of keywords 311-316 that are spoken by the users 302 and 304 and generates the task 320 based on the content of the keywords 311-316.

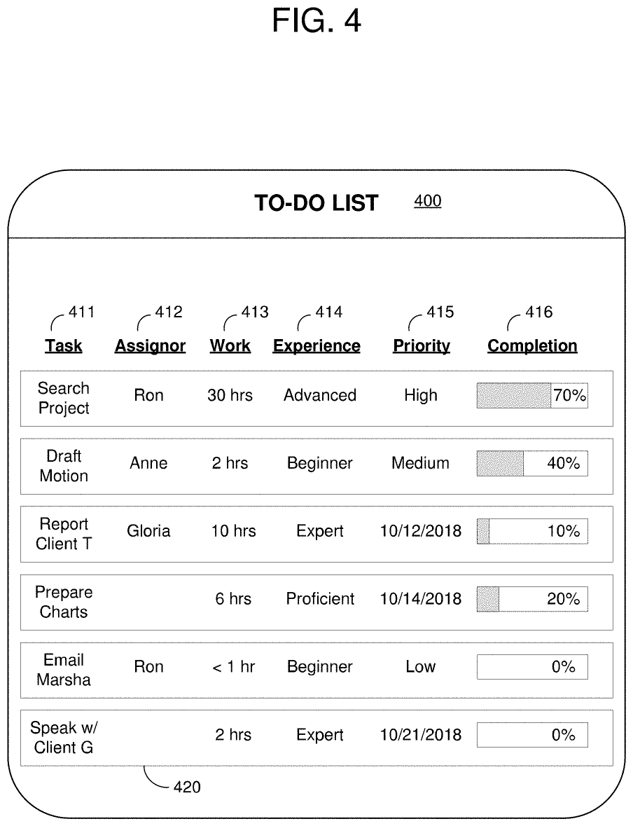

FIG. 4 illustrates an example of a task list 400 of pending tasks which may be output via a user interface of a user device, according to example embodiments. Referring to FIG. 4, the task list 400 includes a plurality of tasks 420 which have been detected by the platform. Here, the platform may arrange the tasks in an order based on priority. In some embodiments, the tasks include a specific timeline such as shown in the third, fourth, and sixth tasks in the list 400. However, some tasks may not have specific timelines. Therefore, the system may automatically determine a priority of the tasks based on other attributes such as attributes 411-416 which include non-time related attributes. For example, the priority may be determined based on a task type 411, an assignor 412 of the task, an amount of work 413 associated with the task, a level of experience 414 needed to prepare the task, a priority 415 of the task, a completion percentage 416 of the task, and the like. Other attributes may be considered and the examples in FIG. 4 are merely for purposes of example.

According to various embodiments, the platform can derive the experience of an available resource, expertise required to do a task, availability of the resource, consider the work load for a user, a time required to complete the task, create reminders when nearing completion, pop-up the status updates, prioritize on the criticality factor, consider most productive hours on a given day, distinguish from the tasks that require more/less efforts, and the like. In some embodiments, the platform may consider the leave plans/availability of a user, the user's expertise area (such as a user is very experienced with analyzing the data but not so much experience with writing code, etc.,), and the like, to prioritize and allocate to-do activities. Additionally, the platform may not have a ready list that is tagged to an email but can derive information from the email or other source to prepare one. It considers the action item, and tags every person and/or resource available or important to complete a task.

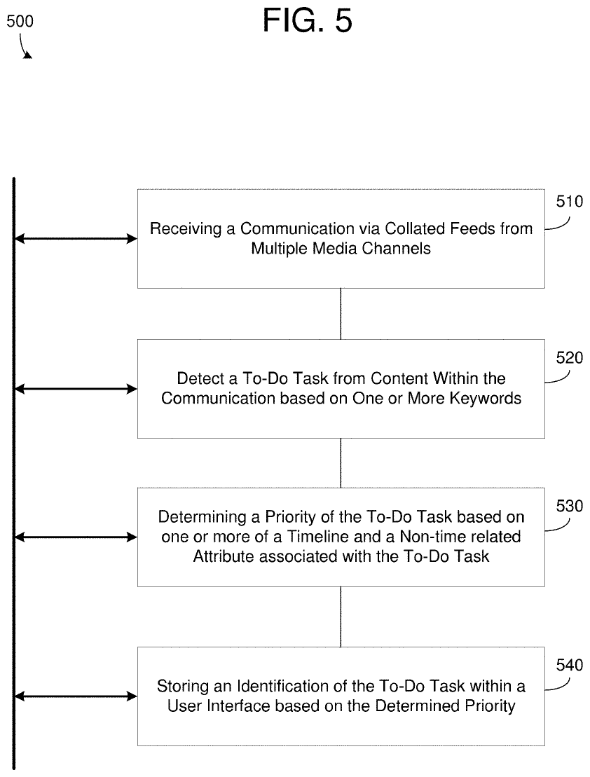

FIG. 5 illustrates a method 500 for detecting a task from a feed collated from multiple media channels according to example embodiments according to example embodiments. For example, the method 500 may be performed by a cloud service, a cloud platform, a server, and the like. Referring to FIG. 5, in 510, the method may include receiving a communication between a sending system and one or more receiving systems via a feed from among a plurality of feeds collated from a plurality of types of media channels. The method may be performed by a centralized platform such as a cloud that receives feeds from different types of medias such as phone calls, emails, instant messages, web browsing activity, and the like. For example, the communication may include an email being sent between the sending system and the receiving system. As another example, the communication may include an audio call between the sending system and the receiving system. The central platform may include an application programming interface (API) or a group of APIs capable of intercepting content between the sending system and the receiving system. In this way, the central system can aggregate tasks from different types of media channels into one central list.

In 520, the method may include detecting a task from content included in the communication based on one or more keywords within the content. For example, if the communication is an email communication, the platform may automatically detect a task based on one or more keywords within a body of the email, within a subject line, within a string of emails sent between sender and receiver, and the like. Here, the method may identify the keywords as being associated with a type of task from among a plurality of types of tasks. In some embodiments, an API may identify the task. In some embodiments, if the communication includes an instant message, the platform may automatically detect a task based on one or more keywords within a SMS, MMS, etc., or a string of instant messages. As another example, if the communication is a phone call, the platform may automatically detect a task based on one or more keywords that are spoken by a user or aggregated from speech of multiple users during the call.

In 530, the method may include determining a priority of the detected task based on one or more of a timeline and a non-time related attribute of the task. Here, the platform may identify a time from content within the communication. As another example, the method may include determining a level of priority (e.g., high, low, medium, etc.) based on a predicted urgency of the task that is determined from content within the communication. In this example, the platform may use machine learning based on one or more of historical tasks, historical communications of the sender and/or receiver, and/or the like, to determine a priority level for the task. In some cases, the priority may be compared with other already pending tasks to identify a priority of the newly detected task with respect to other already pending tasks. In some embodiments, the priority of the tasks may be determined based on non-time attributes. For example, the attributes may include an amount of effort or an amount of work that is likely to be required for the project, a level of experience associated with the task, a type of the task, and the like.

In 540, the method may include storing an identification of the detected task within a task user interface based on the identified priority. For example, the detected task may be stored in a task list in which tasks from multiple media channels are aggregated into a common list and conveniently available for the user in one place. In some embodiments, the tasks may include specific time-limits. As another example, the task list may be arranged based on priority without specific time limits. As another example, the task list may include both time-specific tasks, and non-specific tasks which may be arranged based on urgency. It should also be appreciated that the detected task may be associated with multiple users (which may include other users than a sender and/or a receiver). For example, the task may include a to-do that is associated with a group of users. Here, the platform may generate the task for both the sender and the receiver, and also generate a task for one or more users of the group who are not a sender or a receiver of the communication. The platform may push the task to a user's system for display and approval/rejection by the user. When a user decides to accept a task, the task may be added to a task list of the user.

In some embodiments, the detecting of the task may include identifying a to-do task for both the sender system and a receiving system based on the one or more keywords within the content of the communication. In some embodiments, the method may further include outputting a notice to a screen of one or more of the sending system and a receiving system which requests acceptance of the detected task. Here, the user of the sending system or the receiving system may choose to approve of the saving of the task, or may reject the task. In some embodiments, the platform may draw insight from historical communications of the sending system, the receiving system, other systems, and the like, and predict tasks that may be needed. For example, the platform may auto-suggest an action for addressing the detected task via the user interface based on previously stored communications.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

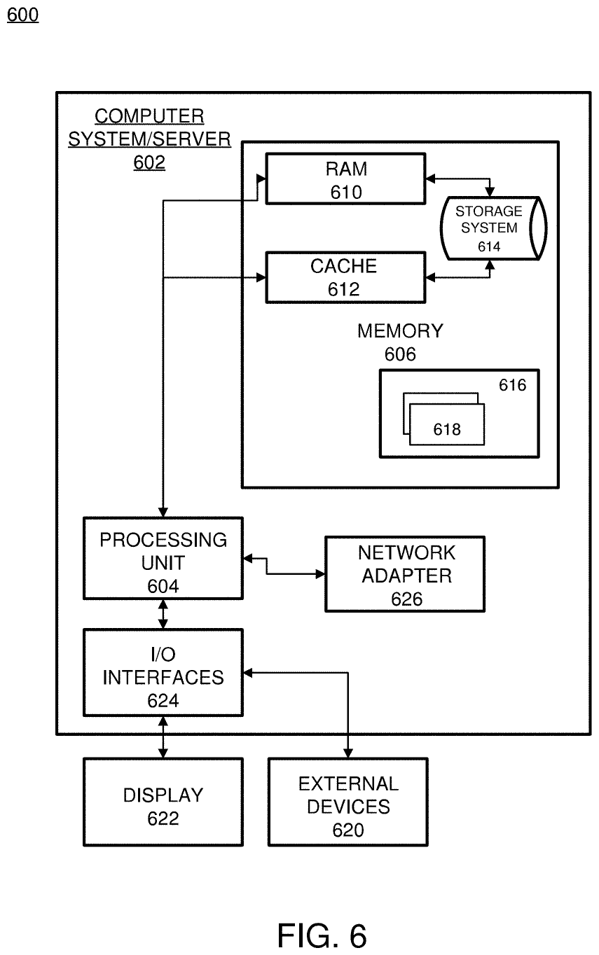

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 6 illustrates an example computer system architecture 600, which may represent or be integrated in any of the above-described components, etc.

FIG. 6 is not intended to suggest any limitation as to the scope of use or functionality of embodiments of the application described herein. Regardless, the computing node 600 is capable of being implemented and/or performing any of the functionality set forth hereinabove. For example, the computing node 600 may be a network server of a larger enterprise network that connects multiple user workstations to the Internet, a private network, or the like.

In computing node 600 there is a computer system/server 602, which is operational with numerous other general purpose or special purpose computing system environments or configurations. Examples of well-known computing systems, environments, and/or configurations that may be suitable for use with computer system/server 602 include, but are not limited to, cloud computing platforms, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server 602 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 602 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 602 in cloud computing node 600 is shown in the form of a general-purpose computing device. The components of computer system/server 602 may include, but are not limited to, one or more processors or processing units (processor) 604, a system memory 606, and a bus that couples various system components including the system memory 606 to the processor 604.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 602 typically includes a variety of computer system readable media. Such media may be any available media that is accessible by computer system/server 602, and it includes both volatile and non-volatile media, removable and non-removable media. System memory 606, in one embodiment, implements the flow diagrams of the other figures. The system memory 606 can include computer system readable media in the form of volatile memory, such as random-access memory (RAM) 610 and/or cache memory 612. Computer system/server 602 may further include other removable/non-removable, volatile/non-volatile computer system storage media. By way of example only, storage system 614 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 606 may include at least one program product having a set (e.g., at least one) of program modules that are configured to carry out the functions of various embodiments of the application.

Program/utility 616, having a set (at least one) of program modules 618, may be stored in memory 606 by way of example, and not limitation, as well as an operating system, one or more application programs, other program modules, and program data. Each of the operating system, one or more application programs, other program modules, and program data or some combination thereof, may include an implementation of a networking environment. Program modules 618 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 602 may also communicate with one or more external devices 620 such as a keyboard, a pointing device, a display 622, etc.; one or more devices that enable a user to interact with computer system/server 602; and/or any devices (e.g., network card, modem, etc.) that enable computer system/server 602 to communicate with one or more other computing devices. Such communication can occur via I/O interfaces 624 (which may be referred to herein as an output and/or an input). Still yet, computer system/server 602 can communicate with one or more networks such as a local area network (LAN), a general wide area network (WAN), and/or a public network (e.g., the Internet) via network adapter 626. As depicted, network adapter 626 communicates with the other components of computer system/server 602 via a bus. It should be understood that although not shown, other hardware and/or software components could be used in conjunction with computer system/server 602. Examples, include, but are not limited to: microcode, device drivers, redundant processing units, external disk drive arrays, RAID systems, tape drives, and data archival storage systems, etc.

According to various embodiments, the network interface 626 may receive a network request from a client device. The processor 604 may detect that a pre-established policy of a cloud tenant has been violated or otherwise triggered based on content included in the received network request. Furthermore, the processor 604 may identify a locale of the client device, and retrieve, at runtime, a tenant message in response to the triggered policy and a custom translation of the tenant message based on the identified locale. Furthermore, the processor 604 may control the network interface 626 to transmit the custom translation of the tenant message to the client device in response to the policy being triggered.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A computing system comprising:
a network interface configured to receive a communication between a sending system and one or more receiving systems via collated feeds from a plurality of types of media channels; and
a processor configured to detect a task to be performed from content included in the communication based on one or more keywords within the content which are associated with a task type from among a plurality of task types, determine a priority of the detected task based on a timeline attribute and a non-time related attribute of the detected task, and store an identification of the detected task within a user interface based on the identified priority.

2. The computing system of claim 1, wherein the feeds includes available communications channels of an organization including at least email communications, instant message communications, and telephone communications.

3. The computing system of claim 1, wherein the processor is configured to automatically detect the task from an email communication based on one or more user-input keywords included in a body of the email.

4. The computing system of claim 1, wherein the processor is configured to automatically detect the task from audio of a telephone call based on one or more user-spoken keywords vocalized during the telephone call.

5. The computing system of claim 1, wherein the processor is configured to automatically detect a task for both the sender system and a receiving system based on the one or more keywords within the content of the communication.

6. The computing system of claim 1, wherein the processor is further configured to output a notice via a display of one or more of the sending system and a receiving system which requests acceptance of the detected task.

7. The computing system of claim 1, wherein the processor is further configured to auto-suggest an action to address the detected task via the user interface based on previously stored communications.

8. The computing system of claim 1, wherein the processor is configured to store the identification of the detected task within a list of tasks based on the identified priority with respect to priorities of other tasks in the list of tasks.

9. The computing system of claim 1, wherein the processor is configured to determine the priority of the task based on one or more non-time related attributes of the task including one or more of an effort associated with the task, a level of experience associated with the task, and a type of the task.

10. A method comprising:
receiving a communication between a sending system and one or more receiving systems via collated feeds from a plurality of types of media channels;
detecting a task to be performed from content included in the communication based on one or more keywords within the content which are associated with a task type from among a plurality of task types;
determining a priority of the detected task based on a timeline attribute and a non-time related attribute of the detected task; and
storing an identification of the detected task within a user interface based on the identified priority.

11. The method of claim 10, wherein the feeds includes available communications channels of an organization including at least email communications, instant message communications, and telephone communications.

12. The method of claim 10, wherein the detecting comprises automatically detecting the task from an email communication based on one or more user-input keywords included in a body of the email.

13. The method of claim 10, wherein the detecting comprises automatically detecting the task from audio of a telephone call based on one or more user-spoken keywords vocalized during the telephone call.

14. The method of claim 10, wherein the automatically detecting comprises identifying a task for both the sender system and a receiving system based on the one or more keywords within the content of the communication.

15. The method of claim 10, further comprising outputting a notice to a screen of one or more of the sending system and a receiving system which requests acceptance of the detected task.

16. The method of claim 10, further comprising auto-suggesting an action for addressing the detected task via the user interface based on previously stored communications.

17. The method of claim 10, wherein the storing comprises storing the identification of the detected task within a list of tasks based on the identified priority with respect to priorities of other tasks in the list of tasks.

18. The method of claim 10, wherein the determining comprises determining the priority of the task based on one or more non-time related attributes of the task including one or more of an effort associated with the task, a level of experience associated with the task, and a type of the task.

19. A non-transitory computer readable medium comprising instructions that when read by a processor cause the processor to perform a method comprising:
receiving a communication between a sending system and one or more receiving systems via collated feeds from a plurality of types of media channels;
detecting a task to be performed from content included in the communication based on one or more keywords within the content which are associated with a task type from among a plurality of task types;
determining a priority of the detected task based on a timeline attribute and a non-time related attribute of the detected task; and
storing an identification of the detected task within a user interface based on the identified priority.

20. The non-transitory computer readable medium of claim 19, wherein the feeds includes available communications channels of an organization including at least email communications, instant message communications, and telephone communications.
